(19) United States
(12) Patent Application Publication
(10) Pub. No.: US 2012/0041157 A9
(43) Pub. Date: Feb. 16, 2012

(54) Cement Additives

(76) Inventors: Takumi Sugamata, Kanagawa (JP); Tomomi Sugiyama, Kanagawa (JP); Raita Iwata, Kanagawa (JP)

(21) Appl. No.: 12/681,795

(22) PCT Filed: Oct. 9, 2008
(86) PCT No.: PCT/EP08/63542

§ 371 Date: Jul. 13, 2010

(30) Foreign Application Priority Data
Oct. 19, 2007 (JP) 07/273031

(51) Int. Cl. C08L 33/10; C08L 33/08

(52) U.S. Cl. 525/451

(57) ABSTRACT

To provide cement additives which render high fluidity and the retention thereof, excellent shrinkage reducing effect and frost-thaw resistance to cement compositions such as mortar and concrete without entraining excessive air, and exhibit excellent solution stability.

The present cement additives contain alkenyl group-containing polyalkylene compounds (SR), ester-based polycarboxylic acid copolymers (PC1) and ether-based polycarboxylic acid copolymers (PC2).

The present invention relates to cement additives. More closely, the present invention relates to cement additives which render to cement compositions high fluidity and the retention thereof, excellent shrinkage reducing effect and frost-thaw resistance without entraining excessive air, and exhibit excellent solution stability.

Many compounds for improving the shrinkage reducing properties and fluidity of cement compositions such as mortar and concrete have been proposed. For example, a shrinkage reducing agent composed mainly of C₁₋₄ alcohol alkylene oxide adduct or C₁₋₄ alkylphenol alkylene oxide adduct is generally used with an antifoaming agent since it has a disadvantage of entraining excessive air into cement compositions; it involves problems of difficulty in air volume control and reduction in frost-thaw resistance of cement compositions.

In contrast, various kinds of polycarboxylic acid-based cement dispersants for improving the fluidity of cement compositions have been proposed. Polycarboxylic acid-based cement dispersants, which improve the fluidity of cement compositions by their high water-reducing properties, are generally used with an antifoaming agent since they involve a disadvantage of entraining a large volume of air and increasing air volume contained in cement compositions with time; they involve problems of difficulties in air volume control and reduction in frost-thaw resistance of cement compositions.

In addition, the above shrinkage reducing agent and cement dispersants involve also a problem of poor solution stability since antifoaming agents generally have poor compatibility with a water solution of polycarboxylic acid-based cement dispersant, and are easily separated when used in the form of one solution consisting of the mixture thereof.

Responding to the above problems, Reference 1 proposes a shrinkage reducing agent for cement wherein polyalkylene compounds having a C₁₋₉ hydrocarbon group, for example, an alkyl-, alkenyl-, aryl- or cycloalkyl group are impregnated into cement hardened products. Reference 2 proposes a dry-shrinkage reducing agent for cement containing a polyalkylene compound having a C₁₋₈ alkyl group or C₁₋₈ alkenyl group. Reference 3 proposes a cement additive obtained by mixing, in a specific ratio, a polyalkylene compound having a C₁₋₄ alkyl group and a water-soluble polymer obtained by polymerizing an oxyalkylene group-containing unsaturated ester or ether with an unsaturated carboxylic acid, which exhibits excellent self-shrinkage reducing effect even in a low water to powder ratio.

Reference 4 proposes a cement additive composed essentially of a polycarboxylic acid-based copolymer containing a polyalkyleneimine-based monomer as an essential constituting unit and a polyalkylene-based ether compound having a C₁₋₈ alkyl group, which exhibits good self-shrinkage reducing effect in the ultra high strength range and excels in making low viscosity concrete. Reference 5 proposes an admixture which is an admixture composition for hydraulic materials containing a polyalkylene-based shrinkage reducing agent having a C₂₋₃₀ hydrocarbon group (e.g., alkyl group and cyclic alkyl group) and a polycarboxylic acid-based high performance AE water reducing admixture, which can effectively reduce dry-shrinkage and render fluidity and dispersibility. Reference 6 proposes a cement admixture containing polyalkyleneglycol and a polyalkyleneglycol mono(meth)acrylate/unsaturated carboxylic acid-based copolymer, which can exhibit excellent crack preventing effect by the addition in a small amount and has good fluidity.

Though disclosing the use of polyalkylene compounds as shrinkage reducing agents and arts for improving fluidity and shrinkage reducing properties of cement compositions by the use of polyalkylene compounds with polycarboxylic acid compounds, the above References 1 to 6 disclose no art addressing the improvement of frost-thaw resistance of hardened cement compositions and solution stability of cement additives.

Regarding the arts addressing the improvement of shrinkage reducing properties and frost-thaw resistance of hardened cement compositions, Reference 7 proposes an ad-mixture containing a polyalkylene-based shrinkage reducing agent having a C₁₋₁₀ alkyl-, C₁₋₁₀ cycloalkyl-, alkylphenyl-, C₁₋₁₀ cycloalkylalkyl- or C₁₋₁₀ alkenyl group, an antifoaming agent and a polycarboxylic acid-based water reducing admixture, which excels in shrinkage reducing effect and frost damage resistance. Reference 8 proposes an additive for hydraulic cement compositions, obtained by mixing an allyl- or methallyl group-containing polyalkylene compound, a C₁₋₆ alkyl- or C₄₋₆ cycloalkyl group-containing polyalkylene compound and aliphatic diol diester or aliphatic dicarboxylic acid diester in a specific ratio, which reduces dry-shrinkage and renders resistance against frost-thaw action. The arts disclosed in References 7 and 8 use an antifoaming agent as an essential component, exhibiting insufficient frost-thaw resistance and solution stability.

As stated above, cement additives which can solve all the problems above were not disclosed in prior arts.
[Reference 1] JP Patent Publication No. 2002-226246
[Reference 2] JP Patent Publication No. 2003-171155
[Reference 3] JP Patent Publication No. 2001-302307
[Reference 4] JP Patent Publication No. 2007-153641
[Reference 5] JP Patent Publication No. 2007-76970
[Reference 6] JP Patent Publication No. 2002-12461
[Reference 7] JP Patent Publication No. 2001-294466
[Reference 8] JP Patent Publication No. 2002-338315

The problem to be solved by the present invention is to provide cement additives which render high fluidity and the retention thereof, excellent shrinkage reducing effect and frost-thaw resistance to cement compositions without entraining excessive air, and exhibit excellent solution stability.

As a result of various kinds of examinations for solving the above problem, the present inventors have found that a mixture of a specific polyalkylene compound having a hydrocarbon group, especially an alkenyl group, and a specific polycarboxylic acid copolymer can solve the above problem perfectly, and accomplished the present invention.

The present invention relates to a cement additive essentially comprising: one or more kinds of alkenyl group-containing polyalkylene compounds (SR) represented by the formula (1); one or more kinds of ester-based polycarboxylic acid copolymers (PC1) containing, as essential constituting units, a monomer 1 represented by the formula (2) and a copolymerizable unsaturated carboxylic acid monomer (UC1); and one or more kinds of ether-based polycarboxylic acid copolymers (PC2) containing, as essential constituting units, a monomer 2 represented by the formula (3) and a copolymerizable unsaturated carboxylic acid monomer (UC2):

[R¹-(A¹O)ₛ—R²] (1)

(wherein R¹ is an alkenyl group-containing C₂₋₁₀ alcohol residue, R² is hydrogen or a C₁₋₃₀ hydrocarbon group, A¹O is one or more kinds of C₂₋₄ oxyalkylene groups and s is a mean addition number of moles of A¹O and an integer of 1 to 20);

[R³-(A²O)ₜ—R⁴] (2)

(wherein R³ is an unsaturated monocarboxylic acid- or unsaturated dicarboxylic acid residue represented by the formula (2a))

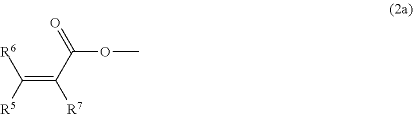

(in the formulae (2) and (2a), R⁴, R⁵ and R⁷ are each independently hydrogen or a methyl group, R⁶ is hydrogen, a methyl group or COOM, M is hydrogen, alkaline metal, alkaline earth metal or (A⁴O)l-R⁸, A²O and A⁴O are one or more kinds of C₂₋₄ oxyalkylene groups, R⁸ is hydrogen or a methyl group, t and l are mean addition numbers of moles of A²O and A⁴O, respectively, and integers of 1 to 100); and

[R⁹-(A³O)ᵤ—R¹⁰] (3)

(wherein R⁹ is an unsaturated alcohol residue represented by the formula (3a)

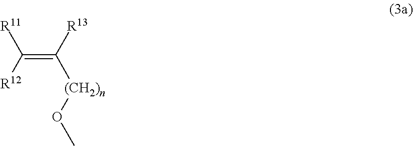

(in the formulae (3) and (3a), R¹⁰, R¹¹, R¹² and R¹³ are each independently hydrogen or a methyl group, A³O is one or more kinds of C₂₋₄ oxyalkylene groups, n is an integer of 0 to 2 and u is a mean addition number of moles of (A³O) and an integer of 1 to 100).

In addition, the present invention relates to the above cement additive, wherein the compounding ratio of the ether-based polycarboxylic acid copolymer (PC2) is 5 to 90 wt % on the basis of the total amount (PC1+PC2) of the ester-based polycarboxylic acid copolymer (PC1) and the ether-based polycarboxylic acid copolymer (PC2).

The present invention further relates to the above cement additive, wherein the compounding ratio of the alkenyl group-containing polyalkylene compound (SR) is 0.1 to 10 wt parts on the basis of the total wt parts (PC1+PC2) of the ester-based polycarboxylic acid copolymer (PC1) and the ether-based polycarboxylic acid copolymer (PC2).

The present cement additive renders to cement compositions high fluidity and the retention thereof, and excellent shrinkage reducing effect and frost-thaw resistance without entraining excessive air, exhibits excellent solution stability.

The present invention is more closely explained in the following section.

The present cement additive essentially comprises: one or more kinds of alkenyl group-containing polyalkylene compounds (SR) represented by the formula (1); one or more kinds of ester-based polycarboxylic acid copolymers (PC1) containing, as essential constituting units, a monomer 1 represented by the formula (2) and a copolymerizable unsaturated carboxylic acid monomer (UC1); and one or more kinds of ether-based polycarboxylic acid copolymers (PC2) containing, as essential constituting units, a monomer 2 represented by the formula (3) and a copolymerizable unsaturated carboxylic acid monomer (UC2).

In the present cement additive, the above alkenyl group-containing polyalkylene compound (SR) is not particularly limited, but should preferably be water-soluble. The compounding ratio of the ether-based polycarboxylic acid copolymer (PC2) should preferably be 5 to 90 wt % on the basis of the total amount (PC1+PC2) of the ester-based polycarboxylic acid copolymer (PC1) and the ether-based polycarboxylic acid copolymer (PC2). As for the alkenyl group-containing polyalkylene compound (SR), the compounding ratio should preferably be 0.1 to 10 wt parts on the basis of the total wt parts (PC1+PC2) of the ester-based polycarboxylic acid copolymer (PC1) and the ether-based polycarboxylic acid copolymer (PC2).

[R¹-(A¹O)ₛ—R²] (1)

(wherein R¹ is an alkenyl group-containing C₂₋₁₀ alcohol residue, R² is hydrogen or a C₁₋₃₀ hydrocarbon group, A¹O is one or more kinds of C₂₋₄ oxyalkylene groups and s is a mean addition number of moles of A¹O and an integer of 1 to 20).

In the formula (1), the compounds having an alkenyl-group containing C₂₋₁₀ alcohol residue include vinyl alcohol, allyl alcohol, propenyl alcohol, isopropenyl alcohol, methallyl alcohol, butenyl alcohol, isobutenyl alcohol, pentenyl alcohol, isopentenyl alcohol, hexenyl alcohol, heptenyl alcohol, octenyl alcohol and nonenyl alcohol, and in terms of shrinkage reducing effect and water solubility, C₂₋₆ alcohols are preferable, and vinyl alcohol, allyl alcohol, methallyl alcohol, butenyl alcohol and isopentenyl alcohol are more preferable.

Considering solution stability, the HLB (Hydrophile-Lipophile Balance: a scale of the balance between hydrophilicity and hydrophobicity) value of the alkenyl group-containing polyalkylene compound (SR) should preferably be not less than 10, more preferably not less than 14.

In the formula (1), A¹O is a C₂₋₄ oxyalkylene group, concretely, ethylene oxide, propylene oxide or butylene oxide. Regarding A¹O, the kinds of polymerization of alkylene oxide to be added are not particularly limited, and may be the single polymerization of one kind of alkylene oxide, or the random copolymerization, block copolymerization or random/block copolymerization of two or more kinds of alkylene oxides; the single polymerization of ethylene oxide is preferable. In the formula (1), s is a mean addition number of moles of A¹O and an integer of 1 to 20, preferably 2 to 12, and more preferably 4 to 10. In the formula (1), R² is hydrogen or a C₁₋₃₀ hydrocarbon group, and in terms of water solubility, it should preferably be hydrogen or a C₁₋₄ hydrocarbon group, more preferably hydrogen or a methyl group.

[R³-(A²O)ₜ—R⁴] (2)

(wherein R³ is an unsaturated monocarboxylic acid- or unsaturated dicarboxylic acid residue represented by the formula (2a))

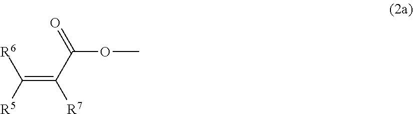

(in the formula (2) and (2a), R⁴, R⁵ and R⁷ are each independently hydrogen or a methyl group, R⁶ is hydrogen, a methyl group or COOM, M is hydrogen, alkaline metal, alkaline earth metal or (A⁴O)l-R⁸, A²O and A⁴O are one or more kinds of C₂₋₄ oxyalkylene groups, R⁸ is hydrogen or a methyl group, t and I are mean addition numbers of moles of A²O and A⁴O, respectively, and integers of 1 to 100).

In the formula (2a), the unsaturated monocarboxylic acid residues or the unsaturated dicarboxylic acid residues include unsaturated monocarboxylic acid residues such as acrylic acid residue, methacrylic acid residue and crotonic acid residue: and unsaturated dicarboxylic acid residues such as maleic acid residue, itaconic acid residue, citraconic acid residue and fumaric acid residue; acrylic acid residue, methacrylic acid residue and maleic acid residue are preferable.

Concretely, the compounds having an unsaturated monocarboxylic acid residue include (poly)oxyethylene(meth)acrylate, (poly)oxyethylene crotonate, (poly)oxypropylene(meth)acrylate, (poly)oxypropylene crotonate, (poly)oxyethylene(poly)oxypropylene(meth)acrylate, (poly)oxyethylene(poly)oxypropylene crotonate, (poly)oxyethylene(poly)oxybutylene(meth)acrylate, (poly)oxyethylene(poly)oxybutylene crotonate, methoxy(poly)oxyethylene(meth)acrylate, methoxy(poly)oxyethylene crotonate, methoxy(poly)oxypropylene(meth)acrylate, methoxy(poly)oxypropylene crotonate, methoxy(poly)oxyethylene(poly)oxypropylene(meth)acrylate, methoxy(poly)oxyethylene(poly)oxypropylene crotonate, methoxy(poly)oxyethylene(poly)oxybutylene(meth)acrylate and methoxy(poly)oxyethylene(poly)oxybutylene crotonate, preferably, (poly)oxyethylene(meth)acrylate, (poly)oxypropylene(meth)acrylate, (poly)oxyethylene(poly)oxypropylene(meth)acrylate, methoxy(poly)oxyethylene(meth)acrylate, methoxy(poly)oxypropylene(meth)acrylate, methoxy(poly)oxyethylene(poly)oxypropylene(meth)acrylate, and more preferably, (poly)oxyethylene(meth)acrylate and methoxy(poly)oxyethylene(meth)acrylate.

Concretely, the compounds having an unsaturated dicarboxylic acid residue include (poly)oxyethylene maleate, (poly)oxyethylene itaconate, (poly)oxyethylene citraconate, (poly)oxyethylene fumarate, (poly)oxypropylene maleate, (poly)oxypropylene itaconate, (poly)oxypropylene citraconate, (poly)oxypropylene fumarate, (poly)oxyethylene(poly)oxypropylene maleate, (poly)oxyethylene(poly)oxypropylene itaconate, (poly)oxyethylene(poly)oxypropylene citraconate, (poly)oxyethylene(poly)oxypropylene fumarate, (poly)oxyethylene(poly)oxybutylene maleate, (poly)oxyethylene(poly)oxybutylene itaconate, (poly)oxyethylene(poly)oxybutylene citraconate, (poly)oxyethylene(poly)oxybutylene fumarate, methoxy(poly)oxyethylene maleate, methoxy(poly)oxyethylene itaconate, methoxy(poly)oxyethylene citraconate, methoxy(poly)oxyethylene fumarate, methoxy(poly)oxypropylene maleate, methoxy(poly)oxypropylene itaconate, methoxy(poly)oxypropylene citraconate, methoxy(poly)oxypropylene fumarate, methoxy(poly)oxyethylene(poly)oxypropylene maleate, methoxy(poly)oxyethylene(poly)oxypropylene itaconate, methoxy(poly)oxyethylene(poly)oxypropylene citraconate, methoxy(poly)oxyethylene(poly)oxypropylene fumarate, methoxy(poly)oxyethylene(poly)oxybutylene maleate, methoxy(poly)oxyethylene(poly)oxybutylene itaconate, methoxy(poly)oxyethylene(poly)oxybutylene citraconate, methoxy(poly)oxyethylene(poly)oxybutylene fumarate, di(poly)oxyethylene maleate, di(poly)oxyethylene itaconate, di(poly)oxyethylene citraconate, di(poly)oxyethylene fumarate, di(poly)oxypropylene maleate, di(poly)oxypropylene itaconate, di(poly)oxypropylene citraconate, di(poly)oxypropylene fumarate, di(poly)oxyethylene(poly)oxypropylene maleate, di(poly)oxyethylene(poly)oxypropylene itaconate, di(poly)oxyethylene(poly)oxypropylene citraconate, di(poly)oxyethylene(poly)oxypropylene fumarate, di(poly)oxyethylene(poly)oxybutylene maleate, di(poly)oxyethylene(poly)oxybutylene itaconate, di(poly)oxyethylene(poly)oxybutylene citraconate, di(poly)oxyethylene(poly)oxybutylene fumarate, dimethoxy(poly)oxyethylene maleate, dimethoxy(poly)oxyethylene itaconate, dimethoxy(poly)oxyethylene citraconate, dimethoxy(poly)oxyethylene fumarate, dimethoxy(poly)oxypropylene maleate, dimethoxy(poly)oxypropylene itaconate, dimethoxy(poly)oxypropylene citraconate, dimethoxy(poly)oxypropylene fumarate, dimethoxy(poly)oxyethylene(poly)oxypropylene maleate, dimethoxy(poly)oxyethylene(poly)oxypropylene itaconate, dimethoxy(poly)oxyethylene(poly)oxypropylene citraconate, dimethoxy(poly)oxyethylene(poly)oxypropylene fumarate, dimethoxy(poly)oxyethylene(poly)oxybutylene maleate, dimethoxy(poly)oxyethylene(poly)oxybutylene itaconate, dimethoxy(poly)oxyethylene(poly)oxybutylene citraconate and dimethoxy(poly)oxyethylene(poly)oxybutylene fumarate, preferably, (poly)oxyethylene maleate, (poly)oxypropylene maleate, (poly)oxyethylene(poly)oxypropylene maleate, methoxy(poly)oxyethylene maleate, methoxy(poly)oxypropylene maleate and methoxy(poly)oxyethylene(poly)oxypropylene maleate, and more preferably, (poly)oxyethylene maleate and methoxy(poly)oxyethylene maleate.

In the formulae (2) and (2a), A²O and A⁴O are one or more kinds of C₂₋₄ oxyalkylene groups, and the kinds of the polymerizations of alkylene oxide to be added are not particularly limited, and may be the single polymerization of one kind of alkylene oxide, or the random copolymerization, block copolymerization or random/block copolymerization of two or more kinds of alkylene oxides. t and l are mean addition numbers of moles of A²O and A⁴O, respectively, and integers of 1 to 100, preferably 5 to 50.

[R⁹-(A³O)ᵤ—R¹⁰] (3)

(wherein R⁹ is an unsaturated alcohol residue represented by the formula (3a)

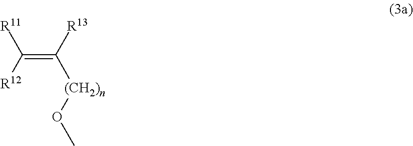

in the formulae (3) and (3a), R¹⁰, R¹¹, R¹² and R¹³ are each independently hydrogen or a methyl group, A³O is one or more kinds of 024 oxyalkylene groups, n is an integer of 0 to 2 and u is a mean addition number of moles of (A³O) and an integer of 1 to 100.

In the formula (3a), the unsaturated alcohol residues include vinyl alcohol residue, allyl alcohol residue, methallyl alcohol residue, butenyl alcohol residue, methylbutenyl alcohol residue, pentenyl alcohol residue and dimethylpropenyl alcohol residue, preferably, vinyl alcohol residue, allyl alcohol residue, methallyl alcohol residue and methylbutenyl alcohol residue. The compounds having these residues concretely include (poly)oxyethylenevinyl ether, (poly)oxyethylene(meth)allyl ether, (poly)oxyethylenebutenyl ether, (poly)oxyethylenemethylbutenyl ether, (poly)oxyethylenepentenyl ether, (poly)oxyethylenedimethylpropenyl ether, (poly)oxyethylenemethylpentenyl ether, (poly)oxyethylenedimethylpentenyl ether, (poly)oxypropylenevinyl ether, (poly)oxypropylene(meth)allyl ether, (poly)oxypropylenebutenyl ether, (poly)oxypropylenemethylbutenyl ether, (poly)oxypropylenepentenyl ether, (poly)oxypropylenedimethylpropenyl ether, (poly)oxypropylenemethylpentenyl ether, (poly)oxypropylenedimethylpentenyl ether, (poly)oxyethylene(poly)oxypropylenevinyl ether, (poly)oxyethylene(poly)oxypropylene(meth)allyl ether, (poly)oxyethylene(poly)oxypropylenebutenyl ether, (poly)oxyethylene(poly)oxypropylenemethylbutenyl ether, (poly)oxyethylene(poly)oxypropylenepentenyl ether, (poly)oxyethylene(poly)oxypropylenedimethylpropenyl ether, (poly)oxyethylene(poly)oxypropylenemethylpentenyl ether, (poly)oxyethylene(poly)oxypropylenedimethylpentenyl ether, (poly)oxyethylene(poly)oxybutylenevinyl ether, (poly)oxyethylene(poly)oxybutylene(meth)allyl ether, (poly)oxyethylene(poly)oxybutylenebutenyl ether, (poly)oxyethylene(poly)oxybutylenemethylbutenyl ether, (poly)oxyethylene(poly)oxybutylenepentenyl ether, (poly)oxyethylene(poly)oxybutylenedimethylpropenyl ether, (poly)oxyethylene(poly)oxybutylenemethylpentenyl ether, (poly)oxyethylene(poly)oxybutylenedimethylpentenyl ether, methoxy(poly)oxyethylenevinyl ether, methoxy(poly)oxyethylene(meth)allyl ether, methoxy(poly)oxyethylenebutenyl ether, methoxy(poly)oxyethylenemethylbutenyl ether, methoxy(poly)oxyethylenepentenyl ether, methoxy(poly)oxyethylenemethylpropenyl ether, methoxy(poly)oxyethylenemethylpentenyl ether, methoxy(poly)oxyethylenedimethylpentenyl ether, methoxy(poly)oxypropylenevinyl ether, methoxy(poly)oxypropylene(meth)allyl ether, methoxy(poly)oxypropylenebutenyl ether, methoxy(poly)oxypropylenemethylbutenyl ether, methoxy(poly)oxypropylenepentenyl ether, methoxy(poly)oxypropylenemethylpropenyl ether, methoxy(poly)oxypropylenemethylpentenyl ether, methoxy(poly)oxypropylenedimethylpentenyl ether, methoxy(poly)oxyethylene(poly)oxypropylenevinyl ether, methoxy(poly)oxyethylene(poly)oxypropylene(meth)allyl ether, methoxy(poly)oxyethylene(poly)oxypropylenebutenyl ether, methoxy(poly)oxyethylene(poly)oxypropylenemethylbutenyl ether, methoxy(poly)oxyethylene(poly)oxypropylenepentenyl ether, methoxy(poly)oxyethylene(poly)oxypropylenemethylpropenyl ether, methoxy(poly)oxyethylene(poly)oxypropylenemethylpentenyl ether, methoxy(poly)oxyethylene(poly)oxypropylenedimethylpentenyl ether, methoxy(poly)oxyethylene(poly)oxybutylenevinyl ether, methoxy(poly)oxyethylene(poly)oxybutylene(meth)allyl ether, methoxy(poly)oxyethylene(poly)oxybutylenebutenyl ether, methoxy(poly)oxyethylene(poly)oxybutylenemethylbutenyl ether, methoxy(poly)oxyethylene(poly)oxybutylenepentenyl ether, methoxy(poly)oxyethylene(poly)oxybutylenemethylpropenyl ether and methoxy(poly)oxyethylene(poly)oxybutylenedimethylpentenyl ether, preferably, (poly)oxyethylenevinyl ether, (poly)oxyethylene(meth)allyl ether, (poly)oxyethylenemethylbutenyl ether, (poly)oxypropylene vinyl ether, (poly)oxypropylene(meth)allyl ether, (poly)oxypropylenemethylbutenyl ether, (poly)oxyethylene(poly)oxypropylenevinyl ether, (poly)oxyethylene(poly)oxypropylene(meth)allyl ether, (poly)oxyethylene(poly)oxypropylenemethylbutenyl ether, methoxy(poly)oxyethylenevinyl ether, methoxy(poly)oxyethylene(meth)allyl ether, methoxy(poly)oxyethylenemethylbutenyl ether, methoxy(poly)oxypropylenevinyl ether, methoxy(poly)oxypropylene(meth)allyl ether, methoxy(poly)oxypropylenemethylbutenyl ether, methoxy(poly)oxyethylene(poly)oxypropylenevinyl ether, methoxy(poly)oxyethylene(poly)oxypropylene(meth)allyl ether and methoxy(poly)oxyethylene(poly)oxypropylenemethylbutenyl ether, and more preferably, (poly)oxyethylenevinyl ether, (poly)oxyethylene(meth)allyl ether, (poly)oxyethylenemethylbutenyl ether, methoxy(poly)oxyethylenevinyl ether, methoxy(poly)oxyethylene(meth)allyl ether and methoxy(poly)oxyethylenemethylbutenyl ether.

In the formulae (3) and (3a), A³O is one or more kinds of C₂₋₄ oxyalkylene groups, and the kinds of the polymerization of alkylene oxides to be added are not particularly limited, and may be the single polymerization of one kind of alkylene oxide, or the random copolymerization, block copolymerization or random/block copolymerization of two or more kinds of alkylene oxides. u is a mean addition number of moles of A³O and an integer of 1 to 100, preferably 5 to 50.

The monomer 1 represented by the formula (2), the monomer 2 represented by the formula (3), the copolymerizable unsaturated carboxylic acid monomers (UC1) and (UC2) include unsaturated monocarboxylic acid-based monomers such as acrylic acid, methacrylic acid and crotonic acid, and the metal salt, ammonium salt and amine salt thereof; unsaturated dicarboxylic acid-based monomers such as maleic acid, itaconic acid, citraconic acid and fumaric acid, and the metal salt, ammonium salt and amine salt thereof; maleic anhydride; itaconic anhydride; and citraconic anhydride. Acrylic acid, methacrylic acid and maleic acid are preferable.

In the present invention, the above ester-based polycarboxylic acid copolymer (PC1) and the ether-based polycarboxylic acid copolymer (PC2) should have a weight average molecular weight in the range of 5,000 to 100,000, preferably 10,000 to 50,000. As long as the purpose of the invention can be achieved, constituting units derived from other copolymerizable monomers in addition to the unsaturated carboxylic acid monomers (UC1) and (UC2) may be contained. The ester-based polycarboxylic acid copolymer (PC1) may be copolymerized with the monomer 2 represented by the formula (3) and the ether-based polycarboxylic acid copolymer (PC2) may be copolymerized with the monomer 1 represented by the formula (2), but production efficiency is reduced because of the complicated production process.

In the present cement additive, the compounding ratio of the ether-based polycarboxylic acid copolymer (PC2) should be 5 to 90 wt %, preferably 15 to 85 wt % of the total amount (PC1+PC2) of the ester-based polycarboxylic acid copolymer (PC1) and the ether-based polycarboxylic acid copolymer (PC2). In the case where the compounding ratio of the ether-based polycarboxylic acid copolymer (PC2) is less than 5 wt %, the dry-shrinkage reducing effect tends to be reduced, and in the case where the compounding ratio exceeds 90 wt %, the frost-thaw resistance tends to be reduced.

In the present cement additive, the compounding ratio of the alkenyl group-containing polyalkylene compound (SR) should be 0.1 to 10 wt parts, preferably 0.25 to 7.5 wt parts of the total wt parts (PC1+PC2) of the ester-based polycarboxylic acid copolymer (PC1) and the ether-based polycarboxylic acid copolymer (PC2). In the case where the compounding ratio of the alkenyl group-containing polyalkylene compound (SR) is less than 0.1 wt parts, the obtained shrinkage reducing effect is insufficient, and in the case where the compounding ratio exceeds 10 wt parts, air entraining property tends to be increased and excessive shrinkage reducing effect is rendered when targeted dispersibility is achieved, resulting in cost inefficiency.

In the present cement additive, the mean addition number of moles (s) of (A¹O) of the alkenyl group-containing polyalkylene compound should be identical with or smaller than at least the larger one of the mean addition number of moles (t) of the alkylene glycol chain part (A²O) of the ester-based polycarboxylic acid copolymer (PC1) or the mean addition number of moles (u) of the alkylene glycol chain part (A²O) of the ether-based polycarboxylic acid copolymer (PC2), and the ratio of the addition numbers of moles should preferably be not more than 0.9. Out of the range, the fluidity of a cement composition and the retention thereof, viscosity suitable for working and shrinkage reducing effect tend to be reduced.

The method for adding the present cement additive is limited in no way, and similarly to the method for adding ordinary cement admixtures, method of mixing the cement additive to cement compositions, method of adding the cement additive to once kneaded concrete compositions or a method of adding the cement additive during the transportation by a concrete mixer truck or after the arrival at a site can properly be employed, and the optimal method can be selected case by case in consideration of the application conditions.

The present cement additives include, but not particularly limited to, ordinary-, moderate heat-, low-heat and white Portland cements; eco-cement produced from raw materials such as municipal waste incinerated ash and sewage sludge incinerated ash; mixed cements obtained by adding mineral fine powder such as blast furnace slag, silica fume, lime stone, fly ash, and gypsum to the above cements; and fast-curing cements obtained by adding aluminate minerals. Mixtures of the above cements may also be used. In addition, hydraulic gypsums such as hemihydrates gypsum and anhydrous gypsum are also used.

The present cement additives include all the additives containing water, sand, crushed stone, other aggregates and admixture in addition to inorganic hydraulic substances; for example, in the case where Portland cement is used as an inorganic hydraulic substance, all of cement paste consisting of cement and water, mortar consisting of cement paste and sand, concrete consisting of mortar and coarse aggregate such as crushed stone and the one with which admixture is mixed are included in the present cement additives.

The present cement additives may be used in combination with other materials if required, as long as the effect is not damaged. For example, water-reducing admixture, high performance AE water-reducing admixture, foaming agent, superplasticizing admixture, setting retarder, promoter, thickener and anticorrosives may be used with the present cement additives.

As the alkenyl group-containing polyalkylene compounds (SR) represented by the formula (1), the ester-based polycarboxylic acid copolymer (PC1) containing, as essential constituting units, the monomer 1 represented by the formula (2) and the polymerizable unsaturated carboxylic acid monomer (UC1), and the ether-based polycarboxylic acid copolymer (PC2) containing, as essential constituting units, the monomer 2 represented by the formula (3) and the copolymerizable unsaturated carboxylic acid monomer (UC2), which are used in the present invention, commercially available products may be used without modification, or ones separately synthesized by usual and publicly-known methods may be used.

### EXAMPLES

The present invention is more closely explained below on the basis of the following examples, but not limited thereto. The kinds of SR used in the present examples and the comparative examples are summarized in Table 1. In Table 1, HLB values were calculated by Griffin's method from the formula weight and molecular weight of ethylene oxide in accordance with the following expression:

TABLE 1

| | SR | | | |
|---|---|---|---|---|
| Compounds | R¹ | (A¹O)₆ | R² | HLB value* |
| SR-1 | allyl alcohl | (EO)₈ | hydrogen | 17.2 |
| SR-2 | allyl alcohl | (EO)₁₆ | hydrogen | 18.5 |
| SR-3 | allyl alcohl | (EO)₁₂ | hydrogen | 18.0 |
| SR-4 | vinyl alcohl | (EO)₄ | hydrogen | 16.0 |
| SR-5 | vinyl alcohl | (EO)₈ | methyl | 17.2 |
| SR-6 | butenyl alcohol | (EO)₁₀ | hydrogen | 17.2 |
| SR-7 | butyl alcohol | (EO)₂ | hydrogen | 10.9 |
| SR-8 | butyl alcohol | (EO)₂(PO)₂ | hydrogen | 6.3 |

HLB value = 20 × (wt % of ethylene oxide)

The kinds of PC1 used in the present examples and the comparative examples are summarized in Table 2.

TABLE 2

| | | | | | | Weight average |
|---|---|---|---|---|---|---|
| | PC1 | | | | | molecular weight |
| | Monomer 1 | | | | Molar ratio | (PEG conversion |
| Compounds | R³ | (A²O)ₜ | R⁴ | UC1 | (Monomer 1:UC1) | by GPC) |
| PC1-1 | methacrylic acid | (EO)₂₅ | methyl | methacrylic acid | 1:2.7 | 27,000 |
| PC1-2 | methacrylic acid | (EO)₁₂ | methyl | methacrylic acid | 1:4 | 20,000 |
| PC1-3 | acrylic acid | (EO)₂₅ | methyl | acrylic acid | 1:5 | 23,000 |

The kinds of PC2 used in the present examples and the comparative examples are summarized in Table 3.

TABLE 3

| | | | | | | Weight average |
|---|---|---|---|---|---|---|
| | PC2 | | | | | molecular weight |
| | Monomer 2 | | | | Molar ratio | (PEG conversion |
| Compounds | R⁹ | (A³O)ᵤ | R¹⁰ | UC2 | (Monomer 2:UC2) | by GPC) |
| PC2-1 | C5 alcohol | (EO)₅₀ | hydrogen | maleic acid | 1:1 | 35,000 |
| PC2-2 | C5 alcohol | (EO)₅₀ | hydrogen | acrylic acid | 1:1 | 35,000 |
| PC2-3 | allyl alcohol | (EO)₄₀ | hydrogen | maleic acid | 1:1 | 10,000 |
| PC2-4 | vinyl alcohl | (EO)₂₅ | hydrogen | maleic acid | 1:1 | 15,000 |
| PC2-5 | vinyl alcohl | (EO)₁₂ | hydrogen | acrylic acid | 1:1.5 | 25,000 |

The combinations of the test conditions of PC1, PC2 and SR are summarized in Table 4. In Table 4, the amount of the cement additive to be added (Cx %) is the weight % on the basis of the mass of the cement contained in concrete.

TABLE 4

| | | | Polycarboxylic acid polymers | | | | |
|---|---|---|---|---|---|---|---|
| | SR | | | | | PC1 + PC2 | Amount of |
| | | Concentration | | | PC1:PC2 | Concentration in | cement additive |
| | Kinds of SR | in solution | Kinds of PC1 | Kinds of PC2 | ratio | solution | to be added |
| Example 1 | SR-1 | 50% | PC1-1 | PC2-1 | 90:10 | 15% | Cx1.0% |
| Example 2 | SR-1 | 50% | PC1-1 | PC2-1 | 75:25 | 15% | Cx1.0% |
| Example 3 | SR-1 | 50% | PC1-1 | PC2-1 | 50:50 | 15% | Cx1.0% |
| Example 4 | SR-1 | 50% | PC1-3 | PC2-1 | 10:90 | 15% | Cx1.0% |
| Example 5 | SR-2 | 50% | PC1-1 | PC2-1 | 75:25 | 15% | Cx1.0% |
| Example 6 | SR-1 | 50% | PC1-1 | PC2-2 | 75:25 | 15% | Cx1.0% |
| Example 7 | SR-1 | 75% | PC1-1 | PC2-1 | 75:25 | 15% | Cx1.0% |
| Example 8 | SR-4 | 50% | PC1-1 | PC2-1 | 75:25 | 15% | Cx1.0% |
| Example 9 | SR-5 | 50% | PC1-1 | PC2-1 | 75:25 | 15% | Cx1.0% |
| Example 10 | SR-6 | 50% | PC1-1 | PC2-1 | 75:25 | 15% | Cx1.0% |
| Example 11 | SR-1 | 50% | PC1-1 | PC2-3 | 75:25 | 15% | Cx1.0% |
| Example 12 | SR-1 | 50% | PC1-1 | PC2-4 | 75:25 | 15% | Cx1.0% |
| Example 13 | SR-3 | 33% | PC1-2 | PC2-5 | 75:25 | 15% | Cx1.5% |
| Comparative | SR-1 | 50% | PC1-1 | — | 100:0 | 15% | Cx1.0% |
| Example 1 | | | | | | | |
| Comparative | SR-1 | 50% | — | PC2-4 | 0:100 | 15% | Cx1.0% |
| Example 2 | | | | | | | |
| Comparative | SR-7 | 50% | PC1-1 | PC2-1 | 75:25 | 15% | Cx1.0% |
| Example 3 | | | | | | | |
| Comparative | SR-8 | 50% | PC1-1 | PC2-1 | 75:25 | 15% | Cx1.0% |
| Example 4 | | | | | | | |
| Comparative | SR-1:SR-8 = 1:t | 50% | PC1-1 | PC2-1 | 75:25 | 15% | Cx1.0% |
| Example 5 | | | | | | | |
| Comparative | — | — | PC1-1 | PC2-1 | 75:25 | 15% | Cx1.0% |
| Example 6 | | | | | | | |

Under the concrete compounding conditions summarized in Table 5, length change test and frost-thaw resistance test were conducted using the cement additives in the amounts as shown in Table 4.

TABLE 5

| Water | | Air | | | | | | |
|---|---|---|---|---|---|---|---|---|
| reducing | Slump | content | | | Unit amount (kg/m³) | | | |
| rate (%) | (cm) | (%) | W/C | s/a | W | C | S | G |
| 18 | 18.0 ± | 4.5 ± | 47.4 | 48.4 | 166 | 350 | 846 | 925 |
| | 1.0 | 0.5 | | | | | | |

Materials used: As cement, ordinary Portland cement available from Taiheiyo Cement (density=3.16 g/cm³), as fine aggregate, land sand from the reservoirs along the Oi River (density in saturated surface-dry condition=2.58 g/cm³, water absorption rate=2.17%, FM=2.70), as coarse aggregate, crushed stone from Oume (density in saturated surface-dry condition=2.65 cm³, solid content=60.7%) were used.

### Length Change Test

Length change rates were calculated in accordance with JIS A 1129-3-2001, using the concrete obtained by the above compounding, and shrinkage reducing properties were evaluated.

### Frost-Thaw Resistance Test

Concrete specimens (10×10×40 cm) were prepared from the concrete obtained by the above compounding. The measurement was conducted in accordance with JIS A1148-2001.

### Solution Stability Test

Solution stabilities of the combinations shown in Table 4 were confirmed at temperatures of 5, 20 and 40 C.

The results of the length change test were summarized in Table 6.

TABLE 6

Length change rate (μ)

| | 1 week | 2 weeks | 4 weeks | 8 weeks |
|---|---|---|---|---|
| Example 1 | −0.025 | −0.033 | −0.052 | −0.066 |
| Example 2 | −0.023 | −0.031 | −0.050 | −0.062 |
| Example 3 | −0.023 | −0.030 | −0.048 | −0.061 |
| Example 4 | −0.021 | −0.027 | −0.045 | −0.060 |
| Example 5 | −0.024 | −0.033 | −0.051 | −0.065 |
| Example 6 | −0.023 | −0.032 | −0.050 | −0.062 |
| Example 7 | −0.021 | −0.026 | −0.043 | −0.059 |
| Example 8 | −0.023 | −0.032 | −0.050 | −0.062 |
| Example 9 | −0.023 | −0.031 | −0.050 | −0.062 |
| Example 10 | −0.024 | −0.032 | −0.050 | −0.062 |
| Example 11 | −0.023 | −0.032 | −0.049 | −0.062 |
| Example 12 | −0.023 | −0.031 | −0.049 | −0.061 |
| Example 13 | −0.023 | −0.032 | −0.050 | −0.063 |
| Comparative | −0.027 | −0.035 | −0.055 | −0.069 |
| Example 1 | | | | |
| Comparative | −0.021 | −0.028 | −0.046 | −0.060 |
| Example 2 | | | | |
| Comparative | −0.019 | −0.025 | −0.041 | −0.057 |
| Example 3 | | | | |
| Comparative | −0.019 | −0.026 | −0.042 | −0.057 |
| Example 4 | | | | |
| Comparative | −0.020 | −0.025 | −0.041 | −0.058 |
| Example 5 | | | | |
| Comparative | −0.029 | −0.042 | −0.059 | −0.073 |
| Example 6 | | | | |

The results of the frost-thaw resistance test were summarized in Table 7.

TABLE 7

| | Relative dynamic modulus (%) | | | | | | | | | |
|---|---|---|---|---|---|---|---|---|---|---|
| | 30 | 60 | 90 | 120 | 150 | 180 | 210 | 240 | 270 | 300 |
| | cycles | cycles | cycles | cycles | cycles | cycles | cycles | cycles | cycles | cycles |
| Example 1 | 98 | 98 | 96 | 95 | 95 | 94 | 93 | 92 | 91 | 91 |
| Example 2 | 98 | 98 | 97 | 97 | 96 | 95 | 94 | 93 | 93 | 90 |
| Example 3 | 97 | 95 | 94 | 93 | 91 | 90 | 89 | 89 | 88 | 88 |
| Example 4 | 93 | 89 | 87 | 83 | 81 | 78 | 77 | 73 | 70 | 67 |
| Example 5 | 98 | 97 | 96 | 96 | 96 | 95 | 93 | 92 | 91 | 90 |
| Example 6 | 98 | 98 | 98 | 97 | 97 | 96 | 95 | 95 | 94 | 93 |
| Example 7 | 99 | 98 | 98 | 97 | 96 | 94 | 94 | 92 | 92 | 90 |
| Example 8 | 98 | 97 | 96 | 95 | 94 | 92 | 92 | 91 | 90 | 87 |
| Example 9 | 98 | 97 | 97 | 96 | 94 | 93 | 92 | 92 | 90 | 88 |
| Example 10 | 99 | 98 | 97 | 97 | 95 | 94 | 94 | 93 | 92 | 90 |
| Example 11 | 98 | 98 | 97 | 96 | 95 | 94 | 94 | 91 | 90 | 89 |
| Example 12 | 98 | 98 | 97 | 96 | 96 | 94 | 93 | 92 | 91 | 90 |
| Example 13 | 98 | 98 | 97 | 96 | 95 | 95 | 94 | 91 | 90 | 89 |
| Comparative | 98 | 98 | 97 | 96 | 95 | 95 | 94 | 93 | 92 | 91 |
| Example 1 | | | | | | | | | | |
| Comparative | 89 | 86 | 78 | 71 | 60 | 52 | 45 | 40 | 38 | 30 |
| Example 2 | | | | | | | | | | |
| Comparative | 82 | 60 | 55 | 47 | 32 | 20 | un- | — | — | — |
| Example 3 | | | | | | | measurable | | | |
| Comparative | 80 | 59 | 50 | 44 | 28 | un- | — | — | — | — |
| Example 4 | | | | | | measurable | | | | |
| Comparative | 82 | 62 | 54 | 48 | 42 | 31 | 24 | un- | — | — |
| Example 5 | | | | | | | | measurable | | |
| Comparative | 99 | 98 | 98 | 97 | 96 | 95 | 95 | 94 | 93 | 92 |
| Example 6 | | | | | | | | | | |

Overall test results were summarized in Table 8.

TABLE 8

| | SR | Polycarboxylic acid polymers | | | Test evaluation | | |
|---|---|---|---|---|---|---|---|
| | Kinds of | Kinds of | Kinds of | PC1:PC2 | Dry | Frost- | Solution |
| | SR | PC1 | PC2 | ratio | Shrinkage | thaw | stability |
| Example 1 | SR-1 | PC1-1 | PC2-1 | 90:10 | ◯ | ⊚ | ◯ |
| Example 2 | SR-1 | PC1-1 | PC2-1 | 75:25 | ⊚ | ⊚ | ◯ |
| Example 3 | SR-1 | PC1-1 | PC2-1 | 50:50 | ⊚ | ⊚ | ◯ |
| Example 4 | SR-1 | PC1-3 | PC2-1 | 10:90 | ⊚ | ◯ | ◯ |
| Example 5 | SR-2 | PC1-1 | PC2-1 | 75:25 | ◯ | ⊚ | ◯ |
| Example 6 | SR-1 | PC1-1 | PC2-2 | 75:25 | ⊚ | ⊚ | ◯ |
| Example 7 | SR-1 | PC1-1 | PC2-1 | 75:25 | ⊚ | ⊚ | ◯ |
| Example 8 | SR-4 | PC1-1 | PC2-1 | 75:25 | ⊚ | ⊚ | ◯ |
| Example 9 | SR-5 | PC1-1 | PC2-1 | 75:25 | ⊚ | ⊚ | ◯ |
| Example 10 | SR-6 | PC1-1 | PC2-1 | 75:25 | ⊚ | ⊚ | ◯ |
| Example 11 | SR-1 | PC1-1 | PC2-3 | 75:25 | ⊚ | ⊚ | ◯ |
| Example 12 | SR-1 | PC1-1 | PC2-4 | 75:25 | ⊚ | ⊚ | ◯ |
| Example 13 | SR-3 | PC1-2 | PC2-5 | 75:25 | ◯ | ⊚ | ◯ |
| Comparative | SR-1 | PC1-1 | — | 100:0 | Δ | ⊚ | ◯ |
| Example 1 | | | | | | | |
| Comparative | SR-1 | — | PC2-4 | 0:100 | ⊚ | Δ | ◯ |
| Example 2 | | | | | | | |
| Comparative | SR-7 | PC1-1 | PC2-1 | 75:25 | ⊚ | X | ◯ |
| Example 3 | | | | | | | |
| Comparative | SR-8 | PC1-1 | PC2-1 | 75:25 | ⊚ | X | X |
| Example 4 | | | | | | | |
| Comparative | SR-1:SR-8 = | PC1-1 | PC2-1 | 75:25 | ⊚ | X | X |
| Example 5 | 1:1 | | | | | | |
| Comparative | — | PC1-1 | PC2-1 | 75:25 | — | ⊚ | — |
| Example 6 | | | | | | | |

### Evaluation Method:

Dry-shrinkage: Compared with the Comparative Example 5, length change rate (8 weeks) not more than 85% is represented by ⊚, 86˜94% is represented by ∘, and not less than 95% is represented by Δ.

Frost-thaw: Under 300 cycles, relative dynamic modulus not less than 80% is represented by ⊚, 60˜79% is represented by ∘, 30˜59% is represented by Δ, and broken on the way ˜29% is represented by x.

Solution stability: No separation observed at temperatures of 5, 20 and 40° C. is represented by ⊚, and separation observed at any one of the temperatures of 5, 20 and 40° C. is represented by x.

Under the concrete compounding conditions shown in Table 5, the present cement additives exhibited a slump of 18.0±1.0 cm, and this indicated that high fluidity could be rendered to the present cement additives. In addition, it was confirmed that said fluidity could be retained at a practically sufficient level.

1. A cement additive essentially comprising: one or more kinds of alkenyl group-containing polyalkylene compounds (SR) represented by the formula (1): one or more kinds of ester-based polycarboxylic acid copolymers (PC1) containing, as essential constituting units, a monomer 1 represented by the formula (2) and a copolymerizable unsaturated carboxylic acid monomer (UC1): and one or more kinds of ether-based polycarboxylic acid copolymers (PC2) containing, as essential constituting units, a monomer 2 represented by the formula (3) and a copolymerizable unsaturated carboxylic acid monomer (UC2):
[R¹-(A¹O)ₛ—R²] (1)
wherein R¹ is an alkenyl group-containing C₂₋₁₀ alcohol residue. R² is hydrogen or a C₁₋₃₀ hydrocarbon group. A¹O is one or more kinds of C₂₋₄ oxyalkylene groups and s is a mean addition number of moles of A¹O and an integer of 1 to 20;
[R³-(A²O)ₜ—R⁴] (2)
wherein R³ is an unsaturated monocarboxylic acid- or unsaturated dicarboxylic acid residue represented by the formula (2a) 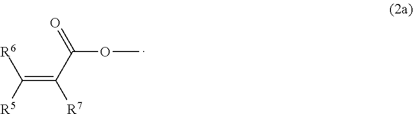
in the formulae (2) and (2a), R⁴, R⁵ and R⁷ are each independently hydrogen or a methyl group. R⁶ is hydrogen, a methyl group or COOM, M is hydrogen, alkaline metal, alkaline earth metal or (A⁴O)l-R⁸. A²O and A⁴O are one or more kinds of C₂₋₄ oxyalkylene groups. R⁸ is hydrogen or a methyl group, t and l are mean addition numbers of moles of A²O and A⁴O, respectively, and integers of 1 to 100; and
[R⁹-(A³O)ᵤ—R¹⁰] (3)
wherein R⁹ is an unsaturated alcohol residue represented by the formula (3a) 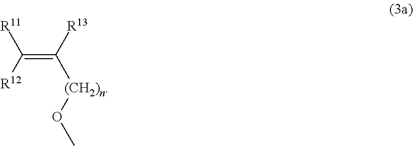
in the formulae (3) and (3a), R¹⁰, R¹¹, R¹² and R¹³ are each independently hydrogen or a methyl group, A³O is one or more kinds of C₂₋₄ oxyalkylene groups, n is an integer of 0 to 2 and u is a mean addition number of moles of (A³O) and an integer of 1 to 100.

2. The cement additive according to claim 1, wherein the compounding ratio of the ether-based polycarboxylic acid copolymer (PC2) is 5 to 90 wt % on the basis of the total amount (PC1+PC2) of the ester-based polycarboxylic acid copolymer (PC1) and the ether-based polycarboxylic acid copolymer (PC2).

3. The cement additive according to claim 1, wherein the compounding ratio of the alkenyl group-containing polyalkylene compound (SR) is 0.1 to 10 wt parts on the basis of the total wt parts (PC1+PC2) of the ester-based polycarboxylic acid copolymer (PC1) and the ether-based polycarboxylic acid copolymer (PC2).

4. The cement additive according to claim 2, wherein the compounding ratio of the alkenyl group-containing polyalkylene compound (SR) is 0.1 to 10 wt parts on the basis of the total wt parts (PC1+PC2) of the ester-based polycarboxylic acid copolymer (PC1) and the ether-based polycarboxylic acid copolymer (PC2).
